(19) United States
(12) Patent Application Publication
(10) Pub. No.: US 2024/0213807 A1
(43) Pub. Date: Jun. 27, 2024

(54) POWER TRANSMITTING DEVICE

(71) Applicant: TOYODA GOSEI CO., LTD., Kiyosu-shi (JP)

(72) Inventors: Yuki TOKUYAMA, Kiyosu-shi (JP); Atsushi SUGIHARA, Kiyosu-shi (JP); Taku KOIKE, Kiyosu-shi (JP); Riho MAMIYA, Nagoya-shi (JP); Shinichiro FUKI, Kiyosu-shi (JP)

(21) Appl. No.: 18/527,483

(22) Filed: Dec. 4, 2023

(30) Foreign Application Priority Data
Dec. 21, 2022 (JP) 2022-204844

(51) Int. Cl. H02J 50/20; B60Q 3/74; B60R 16/03; H02J 50/80

(52) U.S. Cl. CPC H02J 50/20; B60Q 3/74; B60R 16/03; H02J 50/80

(57) ABSTRACT

A power transmitting device includes a power transmitting unit. The power transmitting unit is configured to transmit power through wireless power supply to a power receiving device disposed in a cabin of a mobile unit. At least one front seat and a rear seat are provided in the cabin to be aligned in a front-rear direction of the mobile unit. The interior of the cabin includes a first region that includes a region in which the front seat is disposed and a region on a front side, and a second region that includes a region in which the rear seat is disposed and a region on a rear side. The power transmitting unit is disposed such that a central axis of a power transmittable range in which the power can be transmitted is contained within the second region.

### BACKGROUND

### 1. Field

The present disclosure relates to a power transmitting device of a wireless power supply system.

### 2. Description of Related Art

Wireless power supply supplies power to electrical devices without contact. A typical wireless power supply system includes a power transmitting device and a power receiving device. In this wireless power supply system, power (specifically, radio waves for power transmission) is transmitted from the power transmitting device, and the power is received by the power receiving device.

In order to implement wireless power supply inside a vehicle such as an automobile (specifically, in the cabin), it is conceivable to provide the power transmitting device inside the vehicle. In this case, it is conceivable to install the power transmitting device at a position in the cabin forward of the front seats including the driver's seat (for example, in the instrument panel). Typically, a large number of electrical devices used in driving of the vehicle are provided in front of the driver's seat while being connected to a power source. Therefore, if the power transmitting device is installed in front of the driver's seat, the power transmitting device can be easily connected to the power source.

However, the interior of the cabin is partitioned into a front section and a rear section, by the front seats (mainly, the backrests) including the driver's seat. The rear section includes the rear seat. Therefore, when the power transmitting device is provided in front of the driver's seat, radio waves transmitted from the power transmitting device are obstructed by the front seats and attenuated. In this case, it is difficult to supply power from the power transmitting device to parts of the cabin in the rear section including the rear seat.

Such a problem also occurs in a power transmitting device mounted on a mobile unit other than a vehicle, such as an aircraft, a train, or a spacecraft.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a power transmitting device includes a power transmitting unit configured to transmit power through wireless power supply to a power receiving device disposed in a cabin of a mobile unit. At least one front seat and a rear seat are provided in the cabin so as to be aligned in a front-rear direction of the mobile unit. The at least one front seat includes a driver's seat. An interior of the cabin includes a first region that includes a region in which the at least one front seat is disposed and a region on a front side in the front-rear direction, and a second region that includes a region in which the rear seat is disposed and a region on a rear side in the front-rear direction. The power transmitting unit is disposed such that a central axis of a power transmittable range in which the power can be transmitted is contained within the second region.

Other features and aspects will be apparent from the following detailed description, the drawings, and the claims.

### BRIEF DESCRIPTION OF THE DRAWINGS

FIG. 1 is a schematic side view illustrating a structure of a vehicle in which a power transmitting device according to a first embodiment is employed.

FIG. 2 is a schematic plan view illustrating the structure of the vehicle in which the power transmitting device according to the first embodiment is employed.

FIG. 3 is a schematic diagram showing a configuration of the power transmitting device and a power receiving device according to the first embodiment.

FIG. 4 is a schematic side view illustrating a structure of a vehicle in which a power transmitting device according to a second embodiment is employed.

FIG. 5 is a schematic plan view illustrating the structure of the vehicle in which the power transmitting device according to the second embodiment is employed.

FIG. 6 is a schematic diagram illustrating an arrangement of the power transmitting device according to the second embodiment.

FIG. 7 is a schematic side view illustrating the structure of a vehicle in which a power transmitting device according to a third embodiment is employed.

FIG. 8 is a schematic view showing a structure of a tire and the surrounding area in a vehicle according to a modification.

FIG. 9 is a schematic diagram showing a configuration of a power receiving device according to the modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

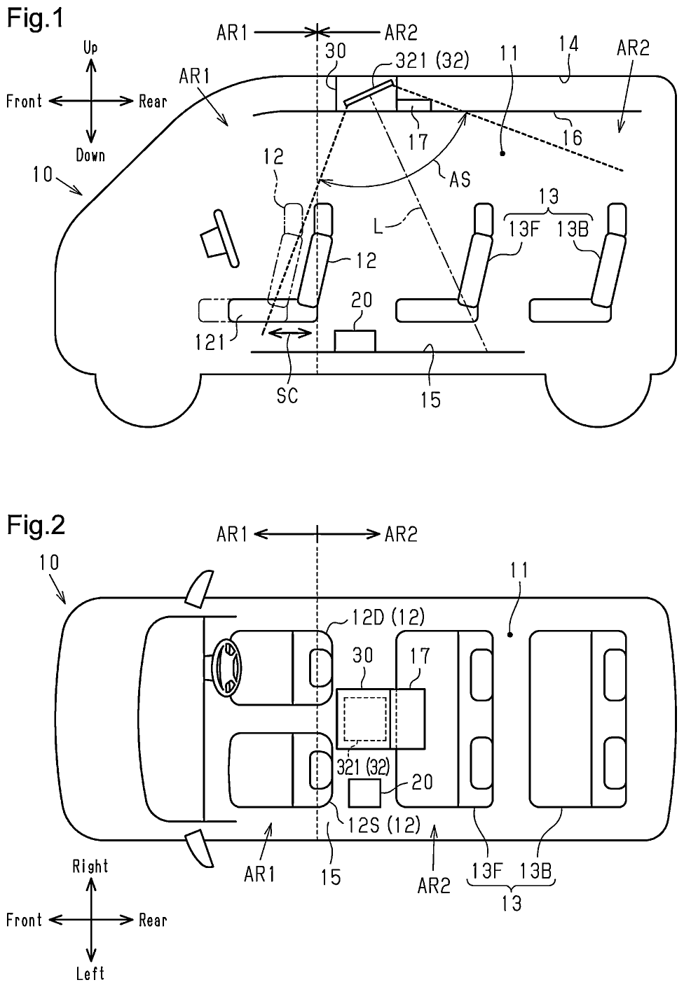

A power transmitting device according to a first embodiment will now be described with reference to FIGS. 1 to 3.

### Vehicle

As shown in FIGS. 1 and 2, a vehicle 10 as a mobile unit has a cabin 11 forming an occupant area. Front seats 12 and rear seats 13 are provided in the cabin 11 so as to be aligned in a front-rear direction of the vehicle 10.

The front seats 12 are disposed on a front side (left side in FIG. 1) inside the cabin 11. The front seats 12 include the driver's seat 12D and a front passenger seat 12S provided on a side of the driver's seat 12D. The driver's seat 12D and the front passenger seat 12S are arranged to be aligned at an interval in a vehicle width direction.

The rear seats 13 are disposed on a rear side (right side in FIG. 1) inside the cabin 11, more specifically, on the rear side of the front seats 12. The rear seats 13 include a second-row seat 13F and a third-row seat 13B. The second-row seat 13F and the third-row seat 13B are arranged to be aligned in the order of the second-row seat 13F and the third-row seat 13B from the front side. The position of the second-row seat 13F in the front-rear direction can be changed.

The vehicle 10 includes an interior light unit 17. The interior light unit 17 includes a light emitting unit (for example, a light bulb) and is connected to a power supply circuit of the vehicle 10 via a wire harness. The interior light unit 17 functions as an interior light that illuminates the interior of the cabin 11. The interior light unit 17 is provided on a ceiling 14, which forms the roof structure of the cabin 11. Specifically, the interior light unit 17 is attached to a position above the second-row seat 13F.

### Wireless Power Supply System

The vehicle 10 includes a wireless power supply system. This wireless power supply system supplies power from a power transmitting device 30 to a power receiving device 20 by radio wave wireless power supply using microwaves in a band from 900 MHz to several tens of GHz. Specifically, the wireless power supply system performs transmission and reception of power transmission signals for wireless power supply between a power transmitting antenna 321 of the power transmitting device 30 and a power receiving antenna 221 of the power receiving device 20.

### Power Receiving Device

The power receiving device 20 is, for example, an electrical component of the vehicle 10. Examples of the power receiving device 20 include a lighting device and an audio device. The power receiving device 20 is provided inside the cabin 11. In the example illustrated in FIG. 1, the power receiving device 20 is provided at a position on a floor 15 between the front seats 12 and the second-row seat 13F in the vehicle 10.

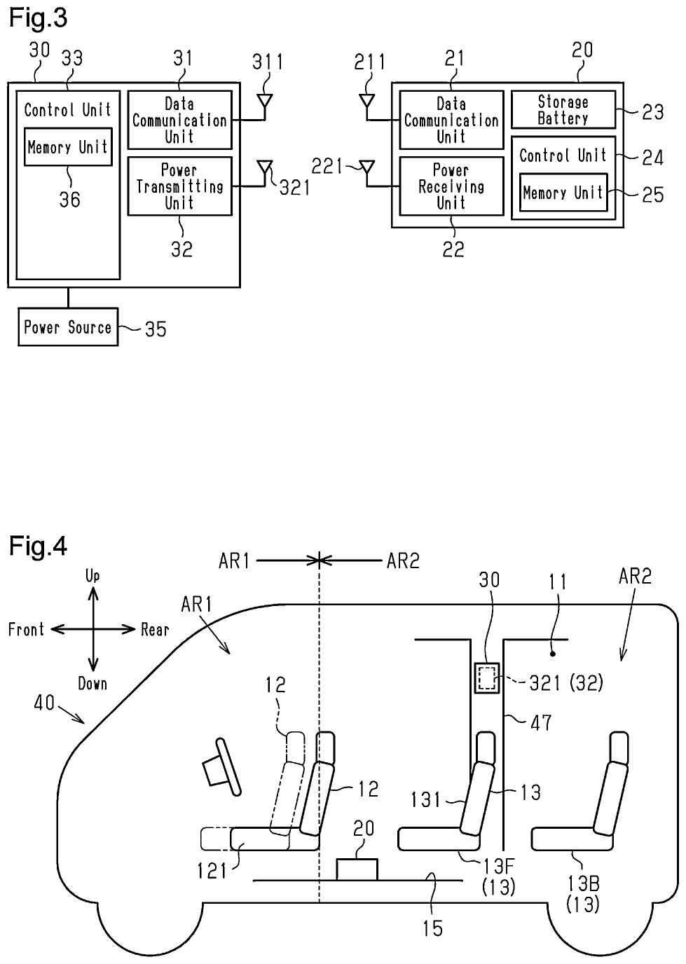

As shown in FIG. 3, the power receiving device 20 includes a data communication unit 21, a power receiving unit 22, a storage battery 23, and a control unit 24.

The data communication unit 21 includes a communication antenna 211. The data communication unit 21 may be configured as circuitry including the communication antenna 211. The data communication unit 21 performs various types of data communication with the power transmitting device 30, such as transmission of a beacon signal including location information, through operation control of the communication antenna 211. The mode of communication in the data communication may be any mode. Examples of such a mode include modes according to communication standards such as Bluetooth (registered trademark), Wi-Fi (registered trademark), or ZigBee (registered trademark).

The power receiving unit 22 includes a power receiving antenna 221. The power receiving unit 22 controls operation of the power receiving antenna 221 to receive power transmission signals transmitted from the power transmitting device 30. The power receiving unit 22 includes a rectifier circuit and a transformer circuit. The power receiving unit 22 converts power transmission signals into DC power by using the rectifier circuit and the transformer circuit. In the present embodiment, the DC power converted by the power receiving unit 22 is supplied to the storage battery 23 to charge the storage battery 23.

The storage battery 23 is a rechargeable battery that stores power. In the present embodiment, the storage battery 23 is used as a power source of the power receiving device 20.

The control unit 24 may include, for example, a microcontroller unit. The control unit 24 may be circuitry including a processor and a memory unit 25. The memory unit 25 includes a read-only memory (ROM) and a random-access memory (RAM). The memory unit 25 stores programs and data for control. The control unit 24 executes various types of control related to operation control of the power receiving device 20, such as operation control of the data communication unit 21 and operation control of the power receiving unit 22.

### Power Transmitting Device

As shown in FIGS. 1 and 2, the power transmitting device 30 is provided on the ceiling 14 of the vehicle 10. The manner in which the power transmitting device 30 is disposed will be described below.

As shown in FIG. 3, the power transmitting device 30 includes a data communication unit 31, a power transmitting unit 32, and a control unit 33.

The data communication unit 31 includes a communication antenna 311. The data communication unit 31 may be configured as circuitry including the communication antenna 311. The data communication unit 31 performs various types of data communication with the power receiving device 20, such as reception of beacon signals through operation control of the communication antenna 311.

The power transmitting unit 32 includes a power transmitting antenna 321. The power transmitting unit 32 may be configured as circuitry including the power transmitting antenna 321. The power transmitting unit 32 converts power supplied from the power source 35 into power transmission signals, and transmits power transmission signals to the power receiving device 20 through operation control of the power transmitting antenna 321.

The control unit 33 may include, for example, a microcontroller unit. The control unit 33 may be circuitry including a processor and a memory unit 36. The memory unit 36 includes a ROM and a RAM. The memory unit 36 stores programs and data for control. The control unit 33 executes various types of control related to operation control of the power transmitting device 30, such as operation control of the data communication unit 31 and operation control of the power transmitting unit 32.

### Operation of Wireless Power Supply System

In the wireless power supply system of the present embodiment, power supply from the power transmitting device 30 to the power receiving device 20 is executed as follows.

As shown in FIG. 2, the power receiving device 20 transmits a beacon signal including location information to the power transmitting device 30 at predetermined time intervals. When the power receiving device 20 is present in a power transmittable range AS, the power transmitting device 30 receives the beacon signal from the power receiving device 20. Upon receiving the beacon signal, the power transmitting device 30 identifies the location of the power receiving device 20 based on the beacon signal. The power transmitting device 30 wirelessly supplies power to the power receiving device 20 by transmitting power transmission signals toward the identified location. This efficiently supplies power to the power receiving device 20 in accordance with, for example, the orientation of the power receiving antenna 221 of the power receiving device 20 with respect to the power transmitting antenna 321 of the power transmitting device 30 and the distance between the power transmitting device 30 and the power receiving device 20.

Since the present embodiment includes the power transmitting device 30, no work is necessary to connect the power receiving device 20, which is an electrical component, to the power supply circuit when the user newly installs the power receiving device 20 inside the cabin 11. In order to connect an electrical component to the power supply circuit, it is only necessary to arrange that electrical component inside the cabin 11. There is no need to perform complicated work such as work for removing an interior trim of the vehicle 10 and work for connecting the power receiving device 20 to a wire harness. As described above, the present embodiment remarkably reduces the time and labor required to newly install an electrical component inside the cabin 11.

In the present embodiment, the power transmitting device 30 (specifically, the power transmitting unit 32) is disposed so as to efficiently transmit power to a region inside the cabin 11 on the side of the front seats 12 on which the rear seats 13 are provided. The arrangement of the power transmitting unit 32 will now be described.

### First Region and Second Region

In the present embodiment, the interior of the cabin 11 is divided into two regions in the front-rear direction. Specifically, a region on the front side in the front-rear direction of the vehicle 10 is defined as a first region AR1, and a region on the rear side in the front-rear direction is defined as a second region AR2.

Specifically, the first region AR1 includes a region in which the front seats 12 are disposed. The rear ends of seat portions 121 of the front seats 12 are defined as a rear end of the first region AR1. In the vehicle 10 of the present embodiment, the position of the front seats 12 is changeable in the front-rear direction as indicated by arrow SC in FIG. 1. In the present embodiment, when the positions of the front seats 12 are set to the rearmost positions in the changeable ranges (indicated by the solid lines in FIG. 1), the position corresponding to the rear ends of the seat portions 121 of the front seats 12 is defined as the rear end of the first region AR1.

The second region AR2 is adjacent to the first region AR1. The second region AR2 includes a region in which the rear seats 13 are disposed.

The power transmitting antenna 321 of the power transmitting unit 32 has a range in which power can be transmitted from the power transmitting antenna 321 (power transmittable range AS shown in FIG. 1). Specifically, the power transmittable range AS is a range in which power transmission signals can be transmitted from the power transmitting antenna 321. The power transmittable range AS has a shape that spreads as the distance from the power transmitting antenna 321 increases. Specifically, the power transmittable range AS has a shape that spreads at a predetermined angle (45 degrees in the present embodiment) around the entire circumference of a central axis L.

In the present embodiment, the power transmitting device 30 is provided on the ceiling 14 of the vehicle 10 such that the central axis L of the power transmittable range AS is contained within the second region AR2 of the cabin 11. The power transmitting device 30 is provided on the ceiling 14 such that the central axis L of the power transmittable range AS extends obliquely downward and obliquely rearward in the vehicle 10 from the power transmitting antenna 321 as the starting point. The power transmitting device 30 is covered with an interior trim 16.

The power transmitting device 30 is provided such that the power transmitting antenna 321 of the power transmitting unit 32 is disposed forward of a middle position in the front-rear direction in second region AR2. Specifically, the power transmitting device 30 is provided in the vicinity of the front end of the second region AR2. The power transmitting device 30 is arranged to be aligned with the interior light unit 17 in the front-rear direction. The power transmitting device 30 is disposed forward of the interior light unit 17. The power transmitting device 30 is integrated with the interior light unit 17.

### Operation and Advantages

Operation and advantages of the power transmitting device 30 according to the present embodiment will now be described.
(1-1) The power transmitting antenna 321 of the power transmitting unit 32 is disposed such that the central axis L of the power transmittable range AS is contained within the second region AR2. According to the present embodiment, the power transmittable range AS is set in the interior of the cabin 11 such that the area between the power transmitting antenna 321 and the second region AR2 is not obstructed by the front seats 12. Accordingly, power from the power transmitting antenna 321 of the power transmitting unit 32 is transmitted to the second region AR2, which is an area closer to the rear seats 13 than the front seats 12 are, without being obstructed by the front seats 12. Therefore, power is efficiently transmitted from the power transmitting unit 32 to the power receiving device 20 disposed in the second region AR2.

Passenger doors (not shown) are disposed on the opposite sides of the second region AR2 of the interior 11. In the vehicle 10, the second-row seat 13F disposed in the second area AR2 is slidable in the front-rear direction. Therefore, the second region AR2 of the interior 11 is a region where there are many restrictions on the arrangement of wire harnesses. Therefore, when an electrical component is disposed in the second region AR2 of the interior 11, it is difficult to connect the electrical component to the power supply circuit. The present embodiment uses the power transmitting device 30 to readily supply power to the power receiving device 20 disposed in the second region AR2.
(1-2) The power transmitting device 30 is provided in the vicinity of the front end of the second region AR2. The power transmitting antenna 321 of the power transmitting unit 32 is provided on the ceiling 14 of the vehicle 10 such that the central axis L of the power transmittable range AS extends obliquely downward and obliquely rearward in the vehicle 10 from the power transmitting antenna 321 as the starting point.

In the present embodiment, the power transmittable range AS has a shape that spreads as the distance from the power transmitting antenna 321 increases. The present embodiment sets the power transmittable range AS inside the cabin 11 such that the power transmittable range AS spreads as it extends obliquely downward and obliquely rearward. This allows the power transmitting unit 32 provided on the ceiling 14 to transmit power not only to an area below the power transmitting unit 32 but also to an area rearward of the power transmitting unit 32. Therefore, power can be transmitted to a wide range in the second region AR2, which forms a region rearward of the cabin 11.
(1-3) The power transmitting device 30 is integrated with the interior light unit 17 provided on the ceiling 14. Since the portion of the ceiling 14 of the vehicle 10 on which the interior light unit 17 is disposed is a portion suitable for illuminating the interior of the cabin 11, it is a portion suitable for transmitting power (specifically, power transmission signals) into the cabin 11. Also, the interior light unit 17 is connected to the power supply circuit of the vehicle 10. According to the present embodiment, since the power transmitting device 30 is integrated with the interior light unit 17, power is transmitted from the power transmitting unit 32 to the second region AR2 in the cabin 11 in a favorable manner. Moreover, the power transmitting device 30 can be readily connected to the power supply circuit. It is also possible to display the power transmission state of the power transmitting device 30 by the illumination mode of the interior light unit 17. For example, the interior light unit 17 can be caused to flash on and off or the color of the emitted light can be changed at the time of an anomaly, in which power transmission by the power transmitting device 30 cannot be performed properly. This allows the power transmitting device 30 to be user-friendly and easy to understand.

### Second Embodiment

A power transmitting device according to a second embodiment will now be described with reference to FIGS. 4 to 6. Differences from the first embodiment will mainly be discussed.

The power transmitting device of the present embodiment is different from the power transmitting device of the first embodiment in that the power transmitting device is attached to a side wall of a cabin.

Hereinafter, the manner in which the power transmitting devices according to the present embodiment are disposed will be described. In the following description, like or the same reference numerals or corresponding reference numerals are given to those components that are similar to the corresponding components in the first embodiment shown in FIGS. 1 to 3, and detailed explanations are omitted.

As shown in FIGS. 4 to 6, pillar members 47 are provided in the opposite sides of a vehicle 40. The pillar members 47 extend in the vertical direction along a backrest 131 of the second-row seat 13F. The pillar members 47 are parts of the side walls of the cabin 11, more specifically, the C pillars of the vehicle 40.

In the present embodiment, the power transmitting device 30 is attached to each pillar member 47. One power transmitting device 30 is provided in each of the pillar members 47 on the opposite sides of the vehicle 40. Each power transmitting device 30 is provided at a position above a middle position in the vertical direction of the cabin 11; more specifically, at a position above the backrest 131 of the second-row seat 13F. Each power transmitting device 30 is covered with an interior trim 16 (see FIG. 6).

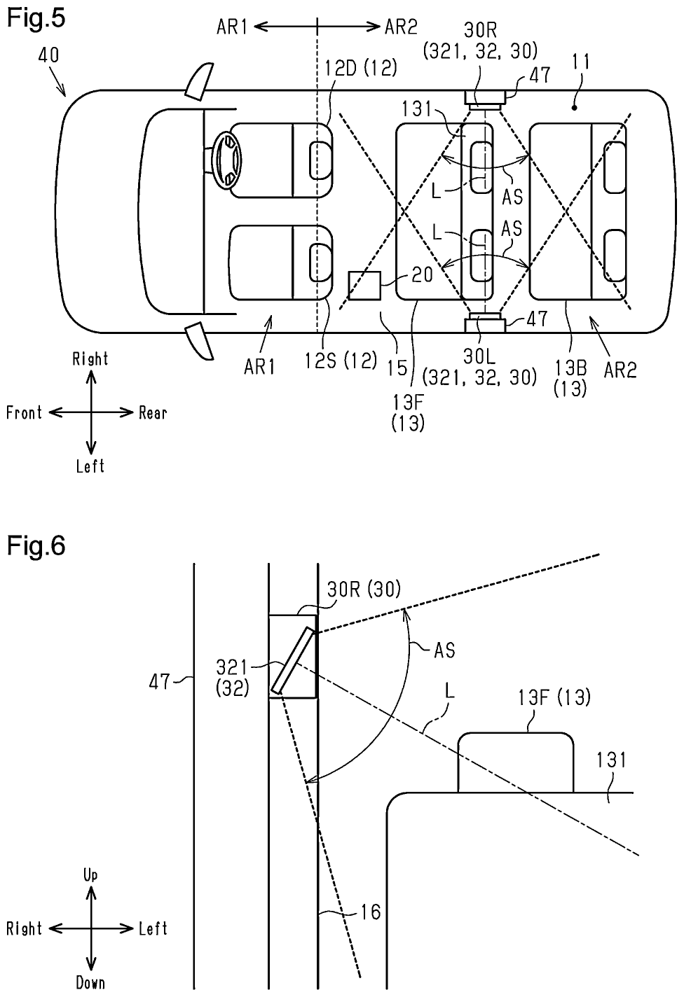

As shown in FIGS. 5 and 6, each power transmitting device 30 is provided in one of the pillar members 47 of the vehicle 40 such that a central axis L of a power transmittable range AS is contained within the second region AR2 of the cabin 11. Accordingly, the power transmittable range AS is set in the interior of the cabin 11 such that the area between the power transmitting antenna 321 and the second region AR2 is not obstructed by the front seats 12. Thus, power from the power transmitting antenna 321 of the power transmitting unit 32 is transmitted to the second region AR2, which is an area closer to the rear seats 13 than the front seats 12 are, without being obstructed by the front seats 12. Therefore, power is efficiently transmitted from the power transmitting unit 32 to the power receiving device 20 disposed in the second region AR2.

As shown in FIG. 6, the power transmitting device 30 provided in the pillar member 47 on the right side of the vehicle 40 (hereinafter referred to as a power transmitting device 30R) is disposed such that the central axis L of the power transmittable range AS extends toward the left side of the vehicle 40 and obliquely downward from the power transmitting antenna 321 as the starting point. As shown in FIG. 5, the power transmitting device 30 provided in the pillar member 47 on the left side of the vehicle 40 (hereinafter referred to as a power transmitting device 30L) is disposed such that the central axis L of the power transmittable range AS extends toward the right side of the vehicle 40 and obliquely downward from the power transmitting antenna 321 as the starting point.

According to the present embodiment, power is transmitted from the power transmitting units 32 provided on the side walls of the cabin 11, specifically, in the pillar members 47, toward the interior of the cabin 11. In addition, the power transmittable range AS of each power transmitting antenna 321 is set inside the cabin 11 such that the power transmittable range AS extends laterally and obliquely downward. This allows the power transmitting unit 32 provided in each side wall of the cabin 11 to transmit power not only to areas located laterally from the power transmitting unit 32 but also to areas located below the power transmitting unit 32. Therefore, power is transmitted from the power transmitting unit 32 to a wide range in the vertical direction in the second region AR2 inside the cabin 11.

The power transmittable range AS has a shape that spreads as the distance from the power transmitting antenna 321 increases. Therefore, the power transmittable range AS is narrow in the vicinity of the power transmitting antenna 321 of each power transmitting device 30. In the present embodiment, the power transmitting devices 30 are provided at the opposite sides of the vehicle 40. Therefore, as is apparent from FIG. 5, power is transmitted to a wide range of the left portion of the cabin 11 from the power transmitting device 30R. On the other hand, power is transmitted to a wide range of the right portion of the cabin 11 from the power transmitting device 30L. As described above, according to the present embodiment, power is transmitted to areas in the second region AR2 close to the side walls of the cabin 11.

### Operation and Advantages

Operation and advantages of the power transmitting device 30 according to the present embodiment will now be described.
(2-1) Each power transmitting device 30 is provided in one of the pillar members 47 of the vehicle 40 such that the central axis L of the power transmittable range AS is contained within the second region AR2 of the cabin 11. Therefore, power is efficiently transmitted from the power transmitting unit 32 to the power receiving device 20 disposed in the second region AR2.
(2-2) The power transmitting devices 30 are provided in the side walls of the cabin 11. Therefore, power can be transmitted from the power transmitting unit 32 of each power transmitting device 30 toward the corresponding side of vehicle 40, that is, toward the interior of the cabin 11.
(2-3) Each power transmitting device 30 is provided at a position above the middle position in the vertical direction of the cabin 11. Each power transmitting device 30 is disposed such that the central axis L of the power transmittable range AS extends toward the corresponding side of the vehicle 40 and obliquely downward from the power transmitting antenna 321 as the starting point. Therefore, power is transmitted to a wide range in the vertical direction in the second region AR2 in the cabin 11.
(2-4) The pillar members 47 extend in the vertical direction along the backrest 131 of the second-row seat 13F. The power transmitting devices 30 are respectively provided in the pillar members 47.

According to the present embodiment, power is transmitted from each power transmitting unit 32 toward the side surface of the backrest 131 of the second-row seat 13F. Accordingly, compared to a case in which power is transmitted toward the front surface (or the rear surface) of the backrest 131 of the second-row seat 13F, the present embodiment reduces the range in which power transmission from the power transmitting units 32 is obstructed by the second-row seat 13F. Power is efficiently transmitted from the power transmitting unit 32 of each power transmitting device 30 to the region forward of the backrest 131 of the second-row seat 13F and the region rearward of the backrest 131 (including the region in which the third-row seat 13B is disposed).

### Third Embodiment

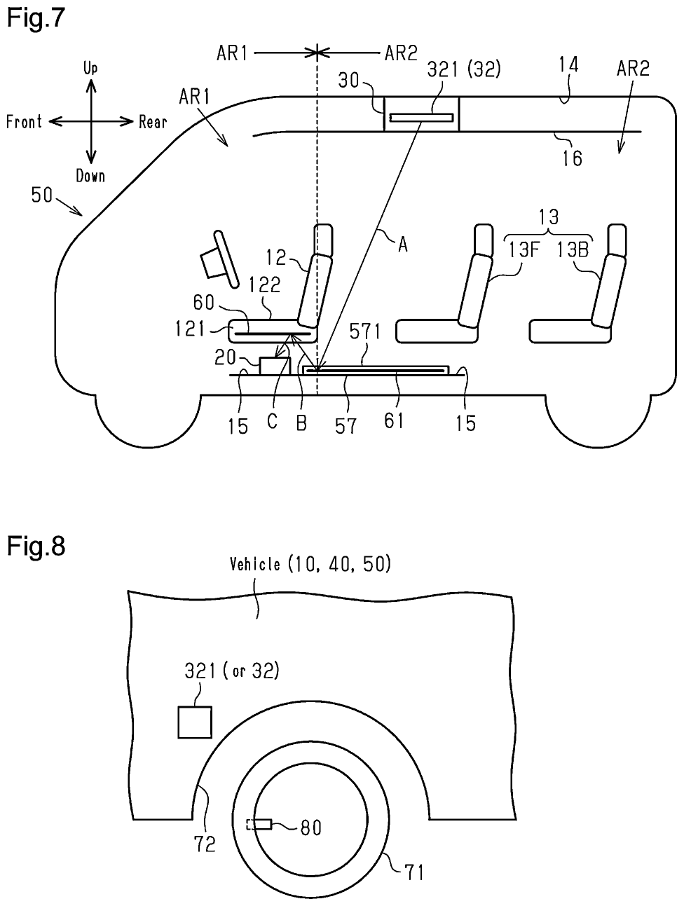

A power transmitting device according to a third embodiment will now be described with reference to FIG. 7. Differences from the first and second embodiments will mainly be discussed.

The power transmitting device according to the present embodiment is different from the power transmitting devices according to the first and second embodiments in that the power transmitting device according to the present embodiment includes reflecting portions that reflect power transmitted from a power transmitting unit.

The reflecting portions according to the present embodiment will be described below. In the following description, like or the same reference numerals or corresponding reference numerals are given to those components that are similar to the corresponding components in the first and second embodiments, and detailed explanations are omitted.

### Reflecting Portions

As shown in FIG. 7, the vehicle 50 is provided with two reflecting portions 60, 61.

The reflecting portion 60 is provided inside the seat portion 121 of each front seat 12. The reflecting portion 60 is formed of a metal plate. The reflecting portion 60 is provided to extend in the vehicle width direction and the front-rear direction. The reflecting portion 60 is covered with an outer layer member 122 of the front seat 12 so that the outer surface of the reflecting portion 60 is not exposed to the interior of the cabin 11.

The reflecting portion 61 is integrated with a floor mat 57. The floor mat 57 is provided at the foot of the second-row seat 13F. The reflecting portion 61 is formed of a metal plate. The reflecting portion 61 is covered with an outer layer member 571 of the floor mat 57 so that the outer surface of the reflecting portion 61 is not exposed to the interior of the cabin 11.

In the present embodiment, the seat portions 121 of the front seats 12 and the floor mat 57 correspond to the components disposed inside the cabin. In the present embodiment, the outer layer members 122, 571 correspond to interior members.

The power receiving device 20 of the present embodiment is fixed to the floor 15 of the vehicle 50. The power receiving device 20 is provided at a position below the seat portion 121 of one of the front seats 12.

In the present embodiment, the power transmitting device 30 is provided on the ceiling 14 of the vehicle 50 such that the central axis L of the power transmittable range AS is contained within the second region AR2 of the cabin 11. The power transmitting device 30 is provided on the ceiling 14 such that the central axis L of the power transmittable range AS extends downward in the vehicle 50 from the power transmitting antenna 321 as the starting point. The power transmitting device 30 is provided at a position above the second-row seat 13F. The power transmitting device 30 is covered with an interior trim 16.

### Operation of Wireless Power Supply System

In the wireless power supply system of the present embodiment, power supply from the power transmitting device 30 to the power receiving device 20 is executed as follows.

As indicated by arrow A in FIG. 7, power (specifically, a power transmission signals) is transmitted downward from the power transmitting antenna 321 of the power transmitting device 30. The power transmission signals are directed to the floor mat 57 provided on the floor 15 of the vehicle 50. Then, the power transmission signals are reflected by the floor mat 57 (specifically, the reflecting portion 61).

As indicated by arrow B in FIG. 7, the power transmission signals reflected by the floor mat 57 travel upward. At this time, the power transmission signals are directed to the lower surface of the seat portion 121 of the front seat 12. Then, the power transmission signals are reflected by the seat portion 121 of the front seat 12 (specifically, the reflecting portion 60).

As indicated by arrow C in FIG. 7, the power transmission signals reflected by the seat portion 121 of the front seat 12 travel downward. In the present embodiment, the power transmission signals at this time are directed to the power receiving device 20 disposed below the front seat 12. The power receiving device 20 thus receives the power transmission signal. In the present embodiment, wireless power supply from the power transmitting device 30 to the power receiving device 20 is performed in this manner.

In the present embodiment, the power receiving device 20 is disposed at an inconspicuous position, which is below the front seat 12. Therefore, if power is simply transmitted from the power transmitting device 30 provided on the ceiling 14 of the vehicle 50 toward the second region AR2 in the cabin 11, it is difficult for the power to reach the power receiving device 20.

In this regard, the present embodiment includes the reflecting portions 60, 61, which reflect the power transmitted from the power transmitting unit 32, inside the cabin 11. According to the present embodiment, it is possible to transmit power from the power transmitting unit 32 to the power receiving device 20 by using reflection of power (specifically, a power transmission signal) at the reflecting portions 60, 61. In the present embodiment, the reflecting portions 60, 61 are disposed to achieve the above-described configuration. As described above, the present embodiment uses reflection of power transmission signals at the reflecting portions 60, 61 to transmit power with high flexibility from the power transmitting unit 32 to various parts of the second region AR2.

In the present embodiment, the outer surfaces of the reflecting portions 60, 61 are covered with the outer layer members 122, 571 so as not to be exposed to the interior of the cabin 11. This prevents the aesthetic appearance of the vehicle 50 from deteriorating due to the reflecting portions 60, 61.

### Operation and Advantages

The present embodiment achieves the following advantages.
(3-1) The present embodiment uses reflection of power transmission signals at the reflecting portions 60, 61 to transmit power with high flexibility from the power transmitting unit 32 to various parts of the second region AR2. Further, the aesthetic appearance of the vehicle 50 is prevented from deteriorating due to the reflecting portions 60, 61.

### Modifications

The above-described embodiments may be modified as follows. The above-described embodiments and the following modifications can be combined as long as the combined modifications remain technically consistent with each other.

In the first embodiment, the power transmitting device 30 may be provided separately from the interior light unit 17.

In the first embodiment, the position of the power transmitting unit 32 on the ceiling 14 may be changed. For example, the power transmitting unit 32 can be disposed at a position away from the front end of the second region AR2 or at a position rearward of the interior light unit 17. In a case in which the power transmitting unit 32 is provided on the ceiling 14 such that the central axis L extends obliquely downward and obliquely rearward from the power transmitting antenna 321 as the starting point, the power transmitting unit 32 is preferably disposed at a position forward of the middle position in the front-rear direction of the second region AR2.

In the first embodiment, the power transmitting unit 32 may be provided such that the central axis L extends directly downward from the power transmitting antenna 321 as the starting point.

In the first embodiment, in a case in which the rear portion of the cabin 11 is a cargo space, the power transmitting device 30 may be provided in the cargo space. According to this configuration, power is efficiently transmitted from the power transmitting unit 32 to the power receiving device 20 disposed in the cargo space.

In the above-described configuration, the power transmitting device 30 is preferably provided such that the power transmitting antenna 321 is disposed above the middle position in the vertical direction in the second region AR2. Also, in the above-described configuration, the power transmitting device 30 is preferably provided such that the central axis L extends obliquely downward and obliquely forward in the vehicle 10 from the power transmitting antenna 321 as the starting point. According to this configuration, power can be transmitted from the power transmitting unit 32 provided at the rear side portion of the ceiling 14 not only to an area below the power transmitting unit 32 but also to an area forward of the power transmitting unit 32. Therefore, power can be transmitted to a wide range in the second region AR2, which forms a region rearward of the cabin 11.

In the second embodiment, in a case in which the pillar members 47 are provided with indirect lighting units that illuminate wall surfaces, the ceiling, or the floor surface of the cabin 11, each indirect lighting unit and the corresponding power transmitting device 30 may be configured integrally. Since the portion of each pillar member 47 in which the indirect lighting unit is disposed is a portion suitable for illuminating the interior of the cabin 11, it is a portion suitable for transmitting power (specifically, power transmission signals) into the cabin 11. Also, the indirect lighting units are connected to the power supply circuit of the vehicle 10. According to the above-described configuration, since each power transmitting device 30 is integrated with the corresponding indirect lighting unit, power is transmitted from the power transmitting unit 32 to the second area AR2 in the cabin 11 in a favorable manner. Moreover, the power transmitting device 30 can be readily connected to the power supply circuit. It is also possible to display the power transmission state of the power transmitting device 30 by the illumination mode of the indirect lighting unit. This allows the power transmitting device 30 to be user-friendly and easy to understand.

In the second embodiment, the power transmitting device 30 may be provided at only one of the opposite sides of the vehicle 40.

In the second embodiment, the power transmitting devices 30 may be provided in portions of the side walls of the cabin 11 other than the pillar members 47 (for example, side panels).

In the second embodiment, the position of the power transmitting unit 32 in each side wall of the cabin 11 may be changed. For example, the power transmitting unit 32 may be disposed at the middle position in the vertical direction or at a position lower than the middle position in the cabin 11. In a case in which each power transmitting unit 32 is provided in the corresponding pillar member 47 such that the central axis L extends obliquely downward and toward the side from the power transmitting antenna 321 as the starting point, the power transmitting unit 32 is preferably disposed at a position above the middle position in the vertical direction in the cabin 11.

In the second embodiment, only the power transmitting unit 32 (or the power transmitting antenna 321), among the components of each power transmitting device 30, may be provided in the corresponding pillar member 47, and the other components may be provided on the ceiling 14.

In the third embodiment, the relative position of the reflecting portion 60 and the power receiving device 20 may be stored in advance in the memory unit 36 of the power transmitting device 30. According to this configuration, power can be transmitted from the power transmitting device 30 to the power receiving device 20 without transmitting and receiving a beacon signal.

In the above-described configuration, the relative position of the reflecting portion 60 and the power receiving device 20 stored in the memory unit 36 may be updated at any time. The update of the relative position can be executed, for example, at the time point when the data communication unit 31 of the power transmitting device 30 receives a beacon signal of the power receiving device 20. According to this configuration, when the power receiving device 20 is moved within the cabin 11 or when an additional power receiving device 20 is provided in cabin 11, power transmission from the power transmitting device 30 to the power receiving devices 20 is performed based on the updated relative position.

The relative position of one power receiving device 20 and each of multiple reflecting portions corresponding to the power receiving device 20 may be stored in advance in the memory unit 36 of the power transmitting device 30. In this configuration, when power transmission through a power transmission route using one or more reflecting portions is impossible, power transmission can be executed using any one of power transmission routes using other reflecting portions, that is, routes through which power can be transmitted from the power transmitting device 30 to the power receiving device 20. In this case, it is preferable to select a route having the shortest power transmission distance from among routes through which power can be transmitted from the power transmitting device 30 to the power receiving device 20.

In the third embodiment, each reflecting portion may be integrated with any component as long as that component is disposed inside the cabin 11. Such components include, for example, a backrest of a seat, a center console, and a retrofitted table. This configuration allows the reflecting portion, which reflects power, to be disposed at various positions so as to be inconspicuous by using components disposed in the cabin 11.

The position at which each reflection portion is provided can be changed to be any position in accordance with the position of the power receiving device 20 as a target of power transmission.

For example, the reflecting portion may be provided between the driver's seat 12D and the front passenger seat 12S. This configuration is achieved by integrating the reflecting portion with the center console or integrating the reflecting portion with the floor mat. According to this configuration, although the power transmitting unit 32 is provided in the second region AR2, power can be transmitted from the power transmitting unit 32 also to the first region AR1 through the gap between the driver's seat 12D and the front passenger seat 12S by using the reflecting portion disposed between the driver's seat 12D and the front passenger seat 12S. Therefore, power is transmitted from the power transmitting unit 32 to the first region AR1 in the cabin 11 without being obstructed by the front seats 12.

In addition, a reflecting portion may be provided in the seat portion of the second-row seat 13F. According to this configuration, power transmission signals transmitted downward from the power transmitting unit 32 provided on the ceiling 14 are reflected upward by the reflecting portion provided in the seat portion of the second-row seat 13F. Thus, power can be transmitted from the power transmitting unit 32 to the power receiving device 20 provided on the ceiling 14.

In each embodiment, the boundary between the first region AR1 and the second region AR2 is not limited to the rear ends of the seat portions 121 of the front seats 12, but may be the front end of the seat portion of the second-row seat 13F. In addition, the boundary may be at any position between the rear ends of the seat portions 121 of the front seats 12 and the front end of the seat portion of the rear seat 13.

The first embodiment and the third embodiment may each include two power transmitting devices 30. One of the power transmitting devices 30 may be provided above the second-row seat 13F, and the other may be provided above the third-row seat 13B. The second embodiment may include two power transmitting devices 30. One of the power transmitting devices 30 may be provided on a side of the second-row seat 13F, and the other may be on a side of the third-row seat 13B.

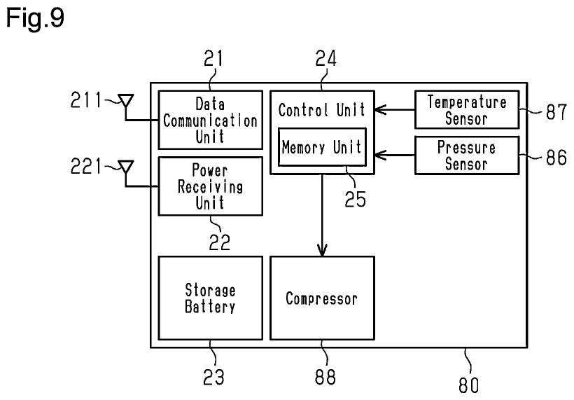

As shown in FIG. 8, in each embodiment, a power receiving device 80 may be provided in a tire 71 of the vehicle 10, 40, 50. The power receiving device 80 is a tire air pressure monitoring device (referred to as TPMS). The power receiving device 80 has a function of automatically adjusting the air pressure of the tire 71. As shown in FIG. 9, the power receiving device 80 includes a data communication unit 21, a power receiving unit 22, a storage battery 23, and a control unit 24. The power receiving device 80 includes a pressure sensor 86 for detecting the air pressure of the tire 71 and a temperature sensor 87 for detecting the temperature of the tire 71. Detection signals of these sensors 86, 87 are input to the control unit 24. The power receiving device 80 further includes a compressor 88 for supplying and discharging air to and from the inside of the tire 71. The compressor 88 is connected to the control unit 24.

The control unit 24 controls operation of the compressor 88 based on the air pressure of the tire 71 detected by the pressure sensor 86 and the temperature of the tire 71 detected by the temperature sensor 87. Through operation control of the compressor 88, the air pressure of the tire 71 is automatically adjusted. In the above-described configuration, power is supplied to the power receiving device 80 from the power transmitting device 30 provided inside the cabin 11.

In the above-described configuration, the power transmitting unit 32 (or the power transmitting antenna 321) of the power transmitting device 30 may be provided in a wheel well 72 (or in the vicinity thereof) as shown in FIG. 8.

In each embodiment, the power transmitting device 30 may be provided in the floor 15 of the vehicle 10, 40, 50.

The power transmitting device 30 according to each embodiment can also be employed in a transmitting device provided in a mobile unit other than the vehicle 10, 40, 50. Examples of such a mobile unit include an aircraft, a ship, and a spacecraft.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A power transmitting device, comprising a power transmitting unit configured to transmit power through wireless power supply to a power receiving device disposed in a cabin of a mobile unit, wherein
at least one front seat and a rear seat are provided in the cabin so as to be aligned in a front-rear direction of the mobile unit, the at least one front seat including a driver's seat,
an interior of the cabin includes:
a first region that includes a region in which the at least one front seat is disposed and a region on a front side in the front-rear direction; and
a second region that includes a region in which the rear seat is disposed and a region on a rear side in the front-rear direction, and
the power transmitting unit is disposed such that a central axis of a power transmittable range in which the power can be transmitted is contained within the second region.

2. The power transmitting device according to claim 1, wherein the power transmitting unit is provided on a ceiling of the mobile unit such that the power transmitting unit is disposed on a front side relative to a middle position in the front-rear direction in the second region, and the central axis extends obliquely downward and obliquely rearward from the power transmitting unit as a starting point in the movable unit.

3. The power transmitting device according to claim 2, wherein
the mobile unit includes an interior light unit that is provided on the ceiling and configured to illuminate the interior of the cabin, and
the power transmitting unit is integrated with the interior light unit.

4. The power transmitting device according to claim 1, wherein the power transmitting unit is provided on a side wall of the cabin.

5. The power transmitting device according to claim 1, further comprising a reflecting portion configured to reflect power transmitted from the power transmitting unit,
wherein the reflecting portion is attached to a component disposed inside the cabin in a state in which an outer surface of the reflecting portion is covered with an interior member so as not to be exposed to the interior of the cabin.

6. The power transmitting device according to claim 5, wherein
the at least one front seat includes the driver's seat and a front passenger seat provided on a side of the driver's seat, and
the reflecting portion is disposed between the driver's seat and the front passenger seat.
